(19) United States
(12) Patent Application Publication
(10) Pub. No.: US 2018/0009447 A1
(43) Pub. Date: Jan. 11, 2018

(54) Wearable with linked accelerometer system

(71) Applicant: BRAGI GmbH, München (DE)

(72) Inventors: Peter Vincent Boesen, München (DE); Felix Hägele, München (DE); Nikolas Müller, München (DE)

(73) Assignee: BRAGI GmbH, München (DE)

(21) Appl. No.: 15/643,936

(22) Filed: Jul. 7, 2017

Related U.S. Application Data
(60) Provisional application No. 62/360,380, filed on Jul. 9, 2016.

(51) Int. Cl. B60W 50/14; B60W 30/04; G08B 3/10; H04R 1/10; B62J 3/00; G01P 1/07; H04B 1/38

(52) U.S. Cl. CPC B60W 50/14; B62J 3/00; B60W 30/04; G01P 1/07; G08B 3/10; H04R 1/1016; B60W 2030/043; B60W 2050/143; B60W 2300/36; H04B 1/38; B60W 2520/18; H04R 2420/07

(57) ABSTRACT

An earpiece includes an earpiece housing, a processor disposed within the ear piece housing, at least one inertial sensor disposed within the earpiece housing, the at least one inertial sensor operatively connected to the processor, and a wireless transceiver disposed within the earpiece housing and operatively connected to the processor. The earpiece is configured to exchange inertial data with a vehicle having one or more inertial sensors. The vehicle may be a motorcycle, moped, scooter, bicycle, electric bicycle, personal transporter, hover board, or other type of vehicle.

### PRIORITY STATEMENT

This application claims priority to U.S. Provisional Patent Application 62/360,380, filed on Jul. 9, 2016, and entitled Wearable with linked accelerometer system, hereby incorporated by reference in its entirety.

### FIELD OF THE INVENTION

The present invention relates to wearable devices. More particularly, but not exclusively, the present invention relates to ear pieces.

### BACKGROUND

Humans are engaged in any number of activities which may involve any number of different types of equipment or vehicles which may include inertial sensors such as accelerometers. What is needed are systems, apparatus, and methods to make the most of data collected from such accelerometers.

### SUMMARY

Therefore, it is a primary object, feature, or advantage of the present invention to improve over the state of the art.

It is a further object, feature, or advantage of the present invention to link data from one or more inertial sensors from equipment or vehicles with wearable devices such as earpieces which include their own inertial sensors.

It is a still further object, feature, or advantage of the present invention to improve performance of a vehicle through use of inertial data collected through one or more earpieces.

Another object, feature, or advantage is to convey inertial data from a vehicle to one or more earpieces of an individual operating the vehicle.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, an earpiece includes an earpiece housing, a processor disposed within the ear piece housing, at least one inertial sensor disposed within the earpiece housing, the at least one inertial sensor operatively connected to the processor, and a wireless transceiver disposed within the earpiece housing and operatively connected to the processor. The earpiece is configured to exchange inertial data with a vehicle having one or more inertial sensors. The vehicle may be a motorcycle, moped, scooter, bicycle, electric bicycle, personal transporter, hover board, or other type of vehicle. The at least one inertial sensor may include a nine axis inertial sensor. The exchange of the inertia data may include receiving inertial data from one or more inertial sensors of the vehicle through the wireless transceiver and may further include sending inertial data from the at least one sensor disposed within the earpiece to the vehicle using the wireless transceiver. The earpiece may further include a speaker and be configured to provide an audio output at the speaker based on data from the at least one inertial sensor and from the inertial data from the vehicle. The audio output may include a verbal instruction, a warning, or a verbal warning.

According to another aspect, a method for communication between a vehicle and an earpiece is provided. The method includes sensing earpiece inertial data with at least one inertial sensor of a wireless earpiece of a rider of the vehicle, sensing vehicle inertial data with at least one inertial sensor of a vehicle, wirelessly communicating the earpiece inertial data from the wireless earpieces to the vehicle, and adjusting a control system of the vehicle based at least in part on the inertial data from the earpiece. The method may further include wirelessly communicating the vehicle inertial data from the vehicle to the wireless earpieces. The vehicle may be a motorcycle and the earpiece inertial data may be indicative of lean of a user of the wireless earpiece on the motorcycle.

### BRIEF DESCRIPTION OF THE DRAWINGS

FIG. 1 illustrates an example of one or more earpieces communicating with a vehicle.

FIG. 2 illustrates a set of earpieces in greater detail.

FIG. 3 is a block diagram of one example of an earpiece.

FIG. 4 is a block diagram of one example of a motorcycle control system.

### DETAILED DESCRIPTION

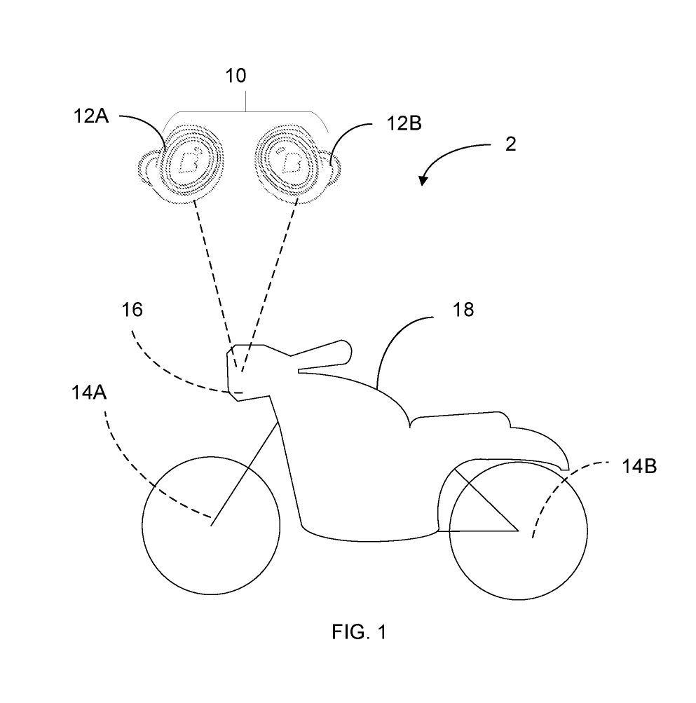

FIG. 1 illustrates various systems 2. As shown in FIG. 1 there is a pair of earpieces 10, which includes a left earpiece 12A and a right earpiece 12B. A vehicle is shown in the form of a motorcycle 18. In operation, the set of earpieces 10 may communicate with the motorcycle 18.

The motorcycle may include one or more inertial sensors such as a first inertial sensor 14A and a second inertial sensor 14B. In addition, the motorcycle has its own electronic control unit (ECU) or other control system 16. The control system 16 may include a wireless transceiver for operative communication with wireless transceivers in one or more of the earpieces 12A, 12B. The earpiece and the control system may be configured to exchange inertial data sensed by the earpiece(s) 12A, 12B and inertial data sensed by the inertial sensors 14A, 14B of the vehicle 18.

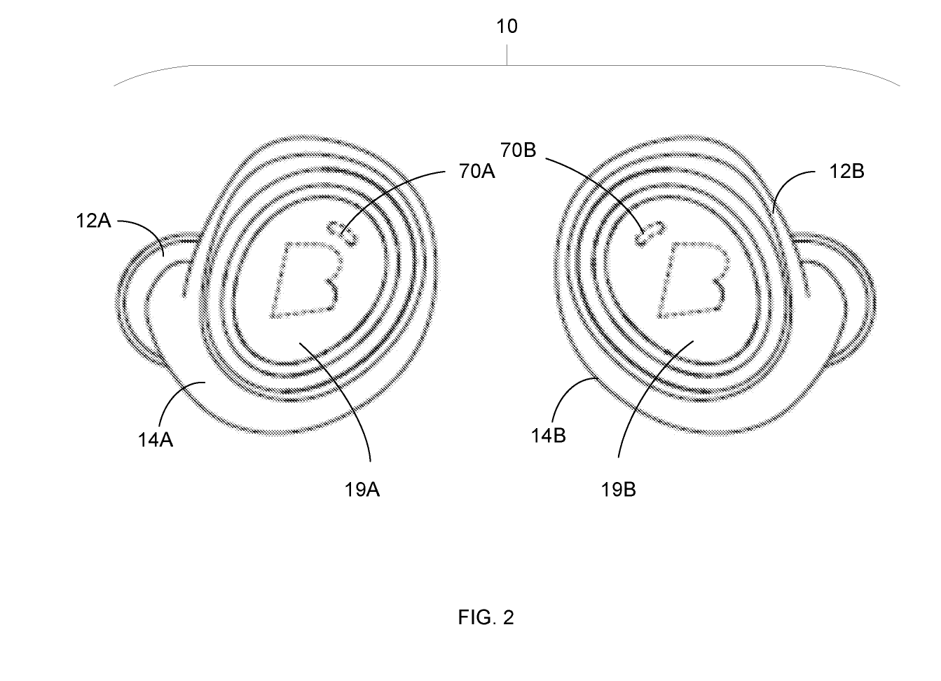

FIG. 2 illustrates the set of earpieces 10 including the left earpiece 12A with a left earpiece housing 14A and the right earpiece 12B with a right earpiece housing 14B. An external microphone 70A is present on the left earpiece 12A and another external microphone 70B is present on the right earpiece. More than one external earpiece may be present on each earpiece.

A touch area 19A is present on the left earpiece and a touch area 19B is present on the right earpiece. In operation, a user may control functionality of the earpieces through interacting through the touch interface. This may include tapping on the touch area, swiping across the touch area (with different directionality having potentially different meaning), or holding a finger against the touch area.

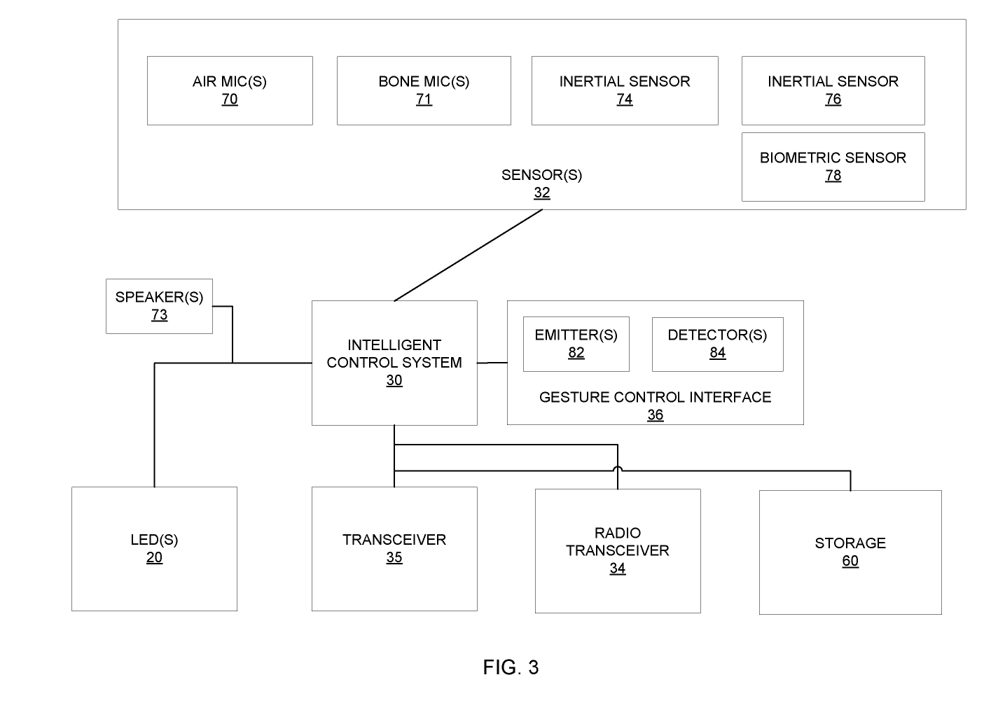

FIG. 3 illustrates one example of a block diagram of an earpiece. As shown in FIG. 3, the earpiece may include one or more sensors 32. Examples of sensors may include an air microphone 70, a bone microphone 71, an inertial sensor 74, another inertial sensor 76, and one or more biometric or physiological sensors 78. The inertial sensors 74, 76 may include accelerometers, gyros, or other types of inertial sensors. For example, each inertial sensor may be a 9-axis inertial sensor which includes a 3-axis gyroscope, a 3-axis accelerometer, and a 3 axis compass. Of course simpler forms of inertial sensors or more complex forms of inertial sensors may be used instead.

The biometric sensors 78 may include any number of different physiological sensors including heart rate monitors, pulse oximeters, temperature sensors, or other type of physiological sensors. An intelligent control system 30 is shown which may comprise one or more processors. A gesture control interface 36 is operatively connected to the intelligent control system 30. The gesture control interface 36 may include one or more emitters and one or more detectors 84 which are used to sense gestures of a user such as a user tapping, holding, or swiping across a touch area of the earpiece. The sensors may provide for capacitive sensing, infrared sensing, other types of light sensing, or other type of emittance and reception to detect types of gestures performed at a touch surface of the earpiece. The intelligent control system 30 is also operatively connected to one or more speakers 73, one or more light elements such as LEDs 20, a memory or storage unit 60, and one or more transceivers 34, 35 which may include a wireless radio transceiver 34 such as may be used for Bluetooth or Bluetooth Low Energy (BLE) communications, or Wi-Fi communications, ultra-wideband, or other type of wireless radio communications such as with other wearable devices, with the motorcycle or other vehicle, with the helmet, with a protection system or otherwise. The transceiver 35 may be a near field magnetic inductance (NFMI) or other type of transceiver which may be used to communicate between earpieces and/or for other purposes as well.

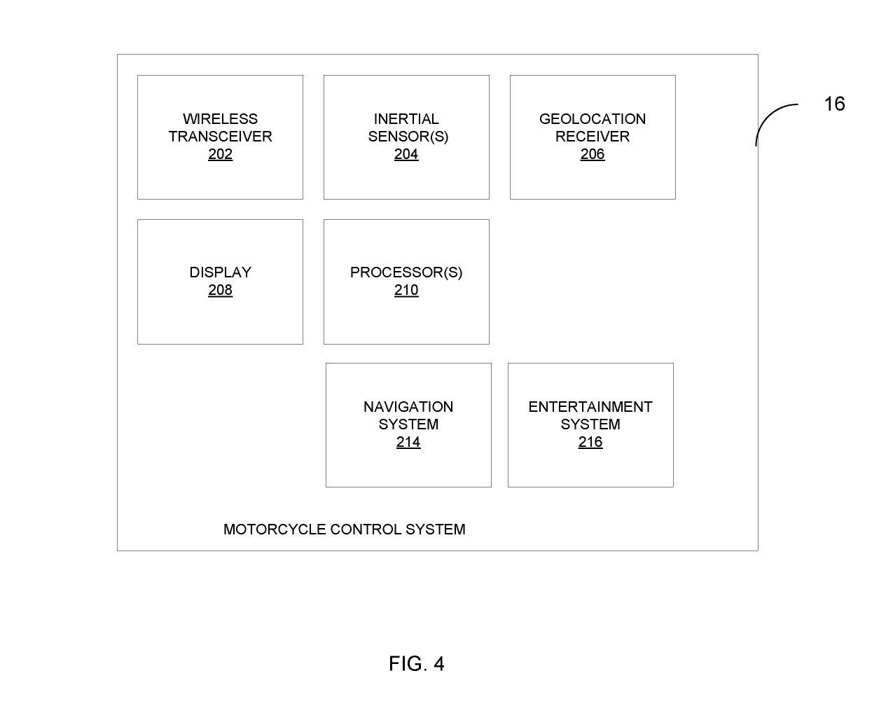

FIG. 4 illustrates one example of a simplified motorcycle control system 16 where one or more processors 210 are shown. The processors 210 may be operatively connected to a wireless transceiver 202, any number of inertial sensors 204, a geolocation receiver 206, one or more displays 208, a navigation system 214, an entertainment system 216 or other systems.

Information from the inertial sensors 204 of the motorcycle may be communicated to the earpieces(s). Similarly, information from the inertial sensors of the earpiece may be communicated to the vehicle. A two-way exchange of inertial data is beneficial in a number of ways. For example, the control system of the vehicle may predict movement of the driver of the motorcycle based on head movement. Thus, when a driver first begins to move, inertial data may be sensed with the earpieces before there is any inertial change detected by inertial sensors on the vehicle itself. Thus, the vehicle may predict movement based on user movement to make any adjustments desirable in advance or in synchronization with the movement. Such adjustments may include stability control adjustments, anti-lock brake system adjustments, traction control system adjustments, and other types of vehicle control adjustments. Where the vehicle is a motorcycle, movement of a user such as sensing that a user is beginning to lean in a particular direction may be detected from inertial sensors in earpieces prior to being sensed at the vehicle.

In addition, inertial change data may be communicated to the earpieces in order to provide audio feedback instead of or in addition to being displayed on a display of the vehicle.

It is also contemplated that earpieces may be worn by a passenger of the vehicle in addition to or instead of the driver of the vehicle. For example, when the vehicle is a motorcycle, operation of the vehicle is affected both by the driver and the passenger. If a passenger is inexperienced and leans too much or leans in the wrong direction, this may create issues for the driver. In one embodiment, both inertial data from earpieces of the driver and inertial data from earpieces of the passenger are communicated to the motorcycle and the motorcycle may provide audible instructions to the driver and/or the passenger through the earpieces regarding the timing or amount of their leaning.

Therefore various methods, systems, and apparatus have been shown and described herein. Although various embodiments have been shown it is to be understood that numerous variations, options, and alternatives are contemplated. This includes variations in the particular sensors of the earpiece, sensors of the motorcycle or other vehicle and variations in any number of variations in the structure, functions, and control methodologies used.

What is claimed is:

1. An earpiece comprising:
an earpiece housing;
a processor disposed within the ear piece housing;
at least one inertial sensor disposed within the earpiece housing, the at least one inertial sensor operatively connected to the processor;
a wireless transceiver disposed within the earpiece housing and operatively connected to the processor;
wherein the earpiece is configured to bi-directionally exchange inertial data with a vehicle having one or more inertial sensors.

2. The earpiece of claim 1 wherein the vehicle is a motorcycle.

3. The earpiece of claim 1 wherein the vehicle is a personal transporter.

4. The earpiece of claim 1 wherein the at least one inertial sensor comprises a nine axis inertial sensor.

5. The earpiece of claim 1 wherein the exchange of the inertial data comprises receiving inertial data from one or more inertial sensors of the vehicle through the wireless transceiver.

6. The earpiece of claim 5 wherein the exchange of the inertial data further comprises sending inertial data from the at least one sensor disposed within the earpiece to the vehicle using the wireless transceiver.

7. The earpiece of claim 1 further comprising a speaker and wherein the earpiece is configured to provide an audio output at the speaker based on data from the at least one inertial sensor and from the inertial data from the vehicle.

8. The earpiece of claim 7 wherein the audio output comprises a verbal instruction.

9. The earpiece of claim 7 wherein the audio output comprises a warning.

10. The earpiece of claim 9 wherein the warning is a verbal warning.

11. The earpiece of claim 1 wherein the vehicle is a motorcycle and wherein the inertial data from the earpiece is indicative of leaning of a user who is riding the motorcycle.

12. The earpiece of claim 11 wherein a control system of the motorcycle is configured to make an adjustment based at least in part on the inertial data form the earpiece.

13. The earpiece of claim 12 wherein the user is a driver of the motorcycle.

14. The earpiece of claim 12 wherein the user is a passenger of the motorcycle.

15. A method for communication between a vehicle and an earpiece, the method comprising:
sensing earpiece inertial data with at least one inertial sensor of a wireless earpiece of a rider of the vehicle;
sensing vehicle inertial data with at least one inertial sensor of a vehicle;
wirelessly communicating the earpiece inertial data from the wireless earpieces to the vehicle;
adjusting a control system of the vehicle based at least in part on the inertial data from the earpiece.

16. The method of claim 15 further comprising wirelessly communicating the vehicle inertial data from the vehicle to the wireless earpieces.

17. The method of claim 15 wherein the vehicle is a motorcycle and wherein the earpiece inertial data is indicative of lean of a user of the wireless earpiece on the motorcycle.

18. The method of claim 17 wherein the user is a driver of the motorcycle.

19. The method of claim 18 wherein the user is a passenger of the motorcycle.
